(19) United States
(12) Patent Application Publication
(10) Pub. No.: US 2005/0108558 A1
(43) Pub. Date: May 19, 2005

(54) Method and apparatus for managing localized emergency splash screens

(75) Inventor: Ulf R. Hanebutte, Gig Harbor, WA (US)

Correspondence Address: Lawrence Cho;c/o PortfolioIP, P.O. Box 52050, Minneapolis, MN, 55402, US

(73) Assignee: Intel Corporation

(21) Appl. No.: 10/716,754

(22) Filed: Nov. 19, 2003

(51) Int. Cl. H04L 9/32

(52) U.S. Cl. 713/193

(57) ABSTRACT

A method for managing data includes synchronizing a database on a client system in response to location information about the client system. A trigger signal is transmitted to the client system in response to an event relevant to the location information of the client system. The trigger signal prompts the client system to present data from the database and to lock the client system.

### FIELD

An embodiment of the present invention relates to computer networks. More specifically, an embodiment of the present invention relates to a method and apparatus for managing localized emergency splash screens on servers and clients on a computer network.

### BACKGROUND

A computer network typically includes a series of computers, often referred to as points or nodes, connected by a communication path. Common topologies for configuring networks include the bus, star, and Token Ring topologies. Networks can be characterized in terms of spatial distances as local area networks (LAN), metropolitan area networks (MAN), and wide area networks (WAN). In some configurations, one or more server systems may be used with a plurality of client systems on a network to facilitate sharing of computing resources, direct the dissemination of information, and manage client system operation.

Computer networks have become instrumental in helping businesses and other organizations efficiently utilize computing resources and share information between workers. For example in some computer networks, server systems have been used to present data, such as emergency messages in the form of splash screens, to users of specific client systems or users of client systems in a specific sub-network of client systems affected by an event.

Many of the current protocols for presenting emergency messages to targeted client systems do not account for an environment where laptop computers are present and mobile computing is available. In these environments, client systems may be at different locations at different times posing a challenge for server systems to identify which client system may be affected by a particular event. In addition, many of the current protocols for presenting emergency messages to specific client systems do not account for the types of messages that may need to be presented to a user of client system that has moved. In most instances, the server system is required to dynamically transmit the emergency message that is to be presented to a user of the client system after the occurrence of an event. When a message to be displayed includes a large amount of data, a significant amount of time may be required to transmit the message. This would result in delaying the execution of the presentation of the emergency message which is undesirable.

Thus, what is needed is an efficient method and apparatus for managing localized emergency splash screens on servers and clients on a computer network.

### BRIEF DESCRIPTION OF THE DRAWINGS

The features and advantages of the present invention are illustrated by way of example and are by no means intended to limit the scope of the present invention to the particular embodiments shown, and in which:

FIG. 1 is a block diagram of a network implementing an embodiment of the present invention;

FIG. 2 is a block diagram of a localized data dispatcher unit on a server system according to an embodiment of the present invention;

FIG. 3 is a block diagram of a localized data manager on a client system according to an embodiment of the present invention;

FIG. 4 is a flow chart illustrating a method of synchronizing data according to an embodiment of the present invention;

FIG. 5 is a flow chart illustrating a method for dispatching data according to an embodiment of the present invention; and

FIG. 6 is a flow chart illustrating a method for managing a client system according to an embodiment of the present invention.

### DETAILED DESCRIPTION

In the following description, for purposes of explanation, specific nomenclature is set forth to provide a thorough understanding of embodiments of the present invention. However, it will be apparent to one skilled in the art that these specific details may not be required to practice the embodiments of the present invention. In other instances, well-known circuits, devices, and programs are shown in block diagram form to avoid obscuring embodiments of the present invention unnecessarily.

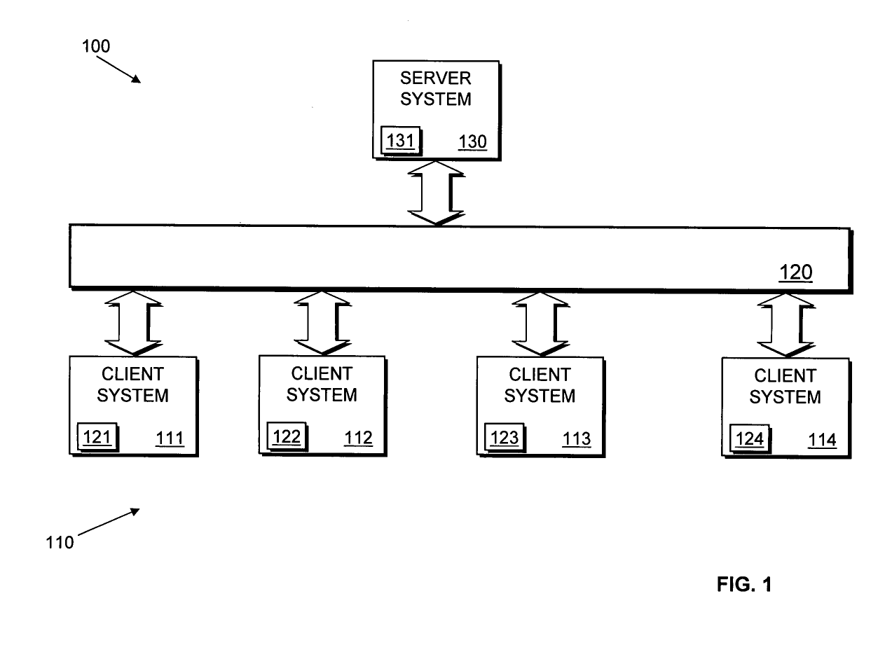

FIG. 1 is a block diagram of an exemplary network 100 implementing an embodiment of the present invention. The network 100 includes a plurality of client systems 111-114 (collectively 110). Client system 111 represents a first client system. Client system 112 represents a second client system. Client system 113 represents a third client system. Client system 114 represents an nth client system where n may be any number. A client system may be a computer system such as a desk top computer, lap top computer, personal digital assistant (PDA), cellular telephone, or other device that is capable of processing data.

The network 100 includes transmission medium 120 which may be used by the client systems 110 to communicate. The transmission medium 120 may include a plurality of physical links. For example, a physical link may be implemented using optical fiber, coaxial cable, twisted pair, or other material. The transmission medium 120 may also include links that support wireless communication. The transmission medium 120 may be used to facilitate a local area network (LAN), wide-area network (WAN), metropolitan-area network (MAN), home-area network (HAN), and/or other types of network.

The network 100 includes server system 130. The server system 130 is a computing system that manages the network 100. The server system 130 includes a localized data dispatcher unit 131. The localized data dispatcher unit 131 maintains a database of data (not shown) that may be presented to users of the client systems 110 upon the occurrence of an event. According to an embodiment of the server system 130, the data may include a splash screen, a plurality of splash screens, and/or other data.

Each of the client systems 110 includes a localized data manager. Client systems 111-114 include localized data managers 121-124 respectively. Each of the localized data managers 121-124 includes a local database of data (not shown) that that may be presented to users of its system. The data presented to a user of a client system upon the occurrence of an event may be unique to the location of a particular client system. Thus, the data in the local database of a client system may be unique to that client system. In addition, the data in a local database of a client system may be updated over time if the client system is moved or if the data in the local database becomes stale. According to an embodiment of the network 100, the server system 130 updates the local databases of the client systems 110 in response to location information of the client systems and information about the data in the local databases of the client systems.

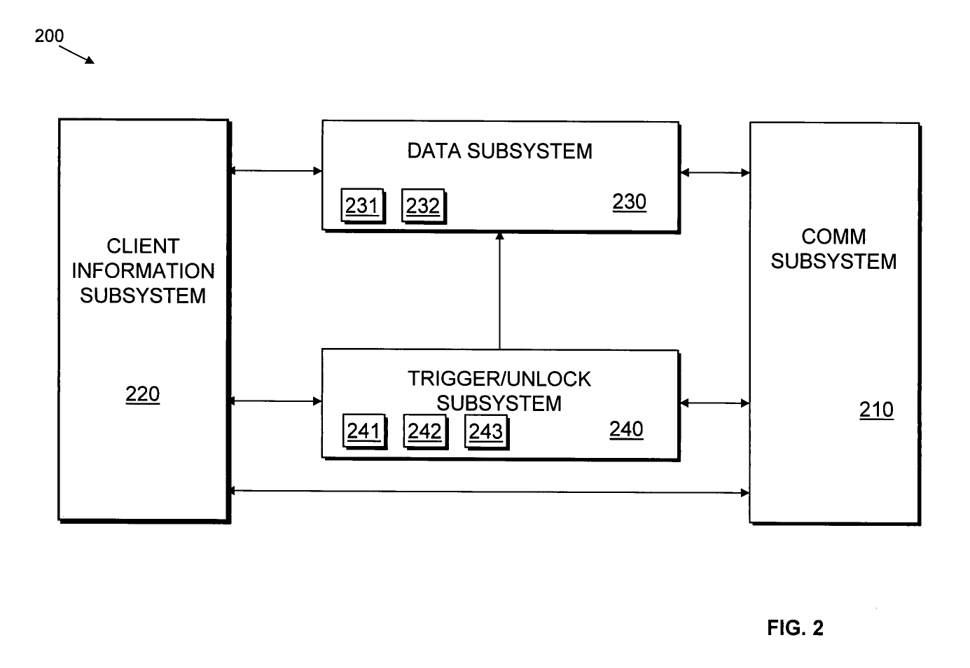

FIG. 2 is a block diagram of a localized data dispatcher unit 200 according to an embodiment of the present invention. The localized data dispatcher unit 200 includes a plurality of modules that may be implemented in software and reside in a main memory of a computer system (not shown) as sequences of instructions. Alternatively, it should be appreciated that the modules of the localized data dispatcher unit 200 may be implemented as hardware or a combination of both hardware and software. The localized data dispatcher unit 200 may be used to implement the localized data dispatcher unit 131 shown in FIG. 1. The localized data dispatcher unit 200 includes a communication subsystem (comm subsystem) 210. The communication subsystem 210 directs data to and from other components in its network and/or other networks. According to one embodiment, the communication subsystem 210 may direct data to and from client systems in the network, other server systems outside the network, or other systems that may broadcast an alert in response to an event.

The localized data dispatcher unit 200 includes a client information subsystem 220. The client information subsystem 220 includes a database of client systems in the network and information about the client systems and/or the users of the client systems. According to an embodiment of the present invention, the client information subsystem 220 receives from the client systems location information regarding where the client systems are. According to an embodiment of the localized data dispatcher unit 200, the client information subsystem 220 maintains a list of client systems in the network and a history of the locations where the client systems have been.

The localized data dispatcher unit 200 includes a data subsystem 230. The data subsystem 230 includes a database 231. The database 231 includes data to present in response to an occurrence of an event. The data may be, for example, a text message or an audible alarm message. The data may be event and/or location specific and be sorted and stored in the database 231 according to events and locations. In one embodiment, the data may include an announcement to indicate the nature of an event and a suggested response. For example, the data may include a splash screen with an announcement that indicates that there is a fire near the current location of a client system. The data may also include a map of the present location of the client system with a safe route of exit.

The data subsystem 230 includes a data manager 232. The data manager 232 synchronizes the contents of local databases in client systems. According to an embodiment of the data subsystem 230, the data manager 232 accesses the location information subsystem unit 220 and retrieves information regarding the current location of a client system. The data manager 232 determines the data in the database 231 that is relevant to the client system based on the current location of the client system. The data manager 232 compares the data that is relevant to the client system to a list of data currently stored in the local database of the client system. According to one embodiment, the list of data is provided to the data manager 232 by the client system via the communication subsystem 210. Data not present on the list and data that has been updated is transmitted to the client system for local storage on its local database via the communication subsystem 210.

The localized data dispatcher unit 200 includes a trigger/unlock subsystem 240. The trigger/unlock subsystem 240 includes a trigger/unlock manager 241. The trigger/unlock manager 241 receives event notifications. The trigger/unlock manager 241 determines whether an event notification includes information about an event that is relevant to a client system in the network. According to an embodiment of the trigger/unlock subsystem 240, relevance may be determined by the location of a client system, attributes of a client system or the user of a client system, or other criteria. In this embodiment, the trigger/unlock manager 241 accesses the client information subsystem 220 to obtain information about the client systems in the network.

The trigger/unlock subsystem 240 includes a trigger execution module 242. In response to the trigger/unlock manager 241 determining that an event is relevant to a client system, the trigger execution module 242 transmits a trigger signal to the client system that identifies data stored in the local database to be presented to a user of the client system. If the data to be displayed at the client system is not available in the local database, the trigger execution module 242 may direct the data to be transmitted to the client system. According to one embodiment, the trigger signal prompts the client system to be put in a lock state where the user is unable to use the client system to perform regular computing operations. It should be appreciated that the trigger signal may be configured to prompt the client system to perform other functions such as, for example, produce an audible alert signal.

The trigger/unlock subsystem 240 includes an unlock module 243. In response to the trigger/unlock manager 241 determining that an event has expired, the unlock module 243 transmits an unlock signal to the client system that prompts the client system to unlock and allow the user to use the client system. The unlock module 243 may also transmit an unlock signal to the client system in response to the trigger/unlock manager 241 determining that the client system has moved to a new location that renders the event triggering the lock to no longer be relevant to the client system.

According to an alternate embodiment of the localized data dispatcher unit 200, the client information subsystem 220 maintains location information for a client system only temporarily until the data subsystem 230 is able to synchronize the local database of the client system. In this embodiment, the trigger/unlock manager 241 is unable to use location information of a client system to determine the relevance of an event to the client system. Thus, in instances where an event is location specific, the trigger execution module 242 broadcasts a trigger signal to all the client systems in the network. The trigger signal includes a location tag. The trigger signal prompts a client system at a location that matches the location tag to present the data and to lock the client system. The unlock module 243 broadcasts an unlock signal to all the client systems in the network. The unlock signal includes a location tag. The unlock signal prompts a client system at a location that matches the location tag to unlock the client system.

According to one embodiment of the localized data dispatcher unit 200, upon determining from location information that a client system has moved to a location that is supported by a second server system, the localized data dispatcher unit 200 may handoff the client system to the second server system. Handing off the client system may include transmitting information about the client system and/or information about the user of the client system to the second server system. After the handoff, the localized data dispatcher unit in the second server system takes on the responsibility of synchronizing the local database of the client system and sending trigger and unlock signals to the client system.

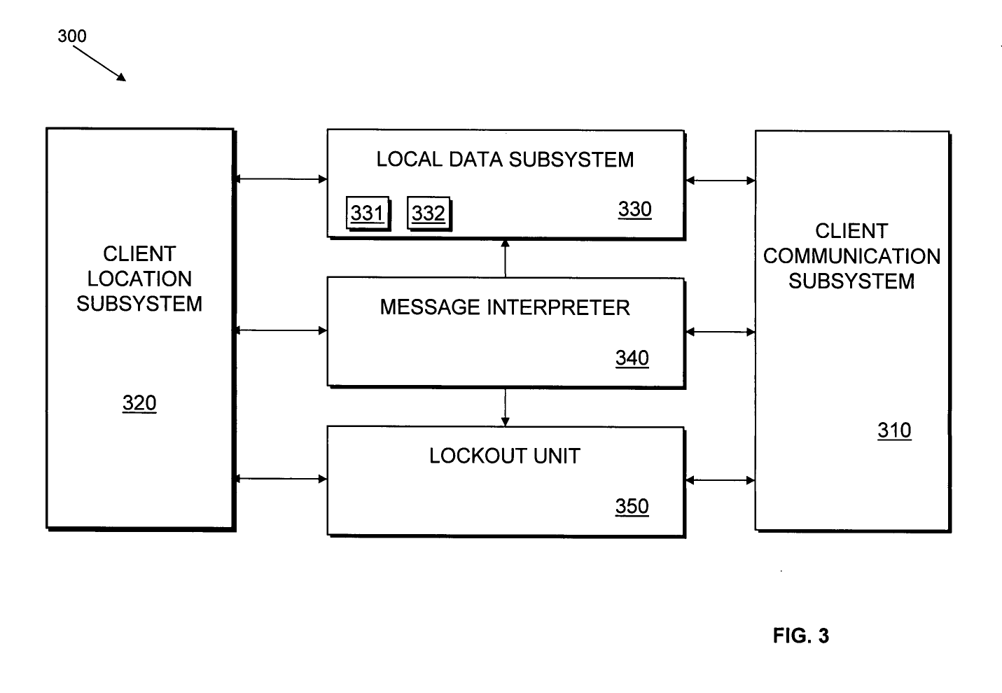

FIG. 3 is a block diagram of a localized data manager 300 in a client system according to an embodiment of the present invention. The localized data manager 300 includes a plurality of modules that may be implemented in software and reside in a main memory of a computer system (not shown) as sequences of instructions. Alternatively, it should be appreciated that the modules of the localized data manager 300 may be implemented as hardware or a combination of both hardware and software. The localized data manager 300 may be used to implement any one of the localized data managers 121-124 shown in FIG. 1. The localized data manager 300 includes a client communication subsystem 310. The client communication subsystem 310 directs data to and from other components in its network and/or other networks. According to an one embodiment, the client communication subsystem 310 may direct data to and from the server system in the network, other server systems outside the network, or other client systems.

The localized data manager 300 includes a client location subsystem 320. The client location subsystem 320 determines a physical location of the client system and generates location information to be sent to the server system. The client location subsystem 320 may utilize one or more position location technologies. A client system may be configured to allow the location subsystem 320 to use a Global Position System (GPS), cell phone triangulation with Enhanced Observed Time of Difference (E-OTD), Digital TV (DTV) signals, wireless local area network (WLAN), and/or other technologies. Each technology has its merits and drawbacks. For example, GPS may offer superior accuracy and precision for determining a position, but has poor performance for tracking indoors. WLAN offers fair accuracy and precision for determining a position, but may be available for only tracking indoors. E-OTD offers poor accuracy and precision for determining a position relative to GPS and WLAN, but may be available anywhere cell coverage is available. The client location subsystem 320 selects the position location technology that is best targeted for the current environment of the client system.

The localized data manager 300 includes a local data subsystem 330. The local data subsystem 330 includes a local database 331. The database 331 includes data to present in response to an occurrence of an event. The data may include, for example, an announcement to indicate the nature of an event and a suggested response. In one embodiment, the data may include a splash screen and/or an audible alarm message.

The local data subsystem 330 includes a local data manager 332. The local data manager 332 synchronizes the contents of the local database 331. According to an embodiment of the local data subsystem 330, the local data manager 332 transmits a list of data currently stored on the local database 331 to a server system. The list of data may include information regarding the time the data was created. In response to sending the list of data and the location data to the server system, the local data subsystem 330 receives new and/or updated data to store in the local database 331. According to an embodiment of the local data subsystem 320, the local data manager 332 may clear the local database 331 of data that has become stale.

The localized data manager 300 includes a message interpreter unit 340. The message interpreter unit 340 receives trigger signals via the client communication interface 310. For trigger signals targeted at the client system, the message interpreter 340 retrieves the data identified by the trigger signal from the local database 331 to be presented by the client system. The message interpreter 340 also directs a lockout unit 350 to lock the client system. The message interpreter unit 340 also receives unlock signals via the client communication interface 310. For trigger signals targeted at the client system, the message interpreter 340 directs the lockout unit 350 to unlock the client system. According to an embodiment of the present invention, the trigger and unlock signals are matching unique pairs. Client systems receiving the matching unique pairs will unlock.

According to an embodiment of the present invention where trigger signals are broadcast to all the client systems on a network, the message interpreter 340 determines whether the trigger signal is applicable to its client system by comparing a location tag on the trigger signal with the current location of the client system. If the location tag matches the current location of the client system, the message interpreter 340 retrieves the data identified by the trigger signal from the local database 331 to be presented and directs the lockout unit 350 to lock the client system. For unlock signals broadcast to client systems on the network, the message interpreter 340 similarly compares the location tag on the signal with that of the current location of the client system to determine whether to direct the lockout unit 350 to unlock the client system.

The localized data manager 300 includes the lockout unit 350. In response to the message interpreter 340, the lockout unit 350 locks and unlocks the client system. When the client system is locked, a user cannot use the client system to perform normal computing operations. For example, when the client system is locked, the input devices such as the keyboard and/or mouse may be disabled. According to an embodiment of the localized data manager 300, the lockout unit 350 enables privileged users to unlock the client system.

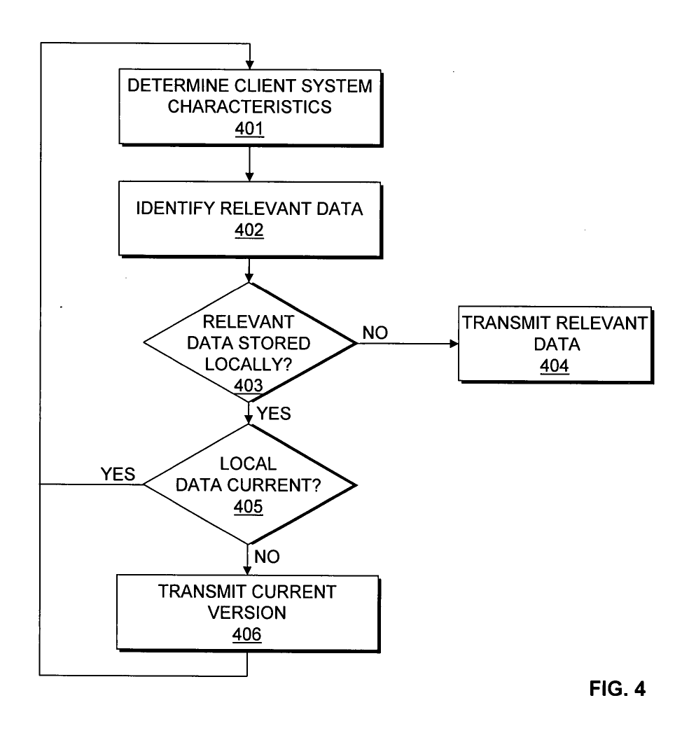

FIG. 4 is a flow chart illustrating a method of synchronizing data according to an embodiment of the present invention. At 401, characteristics about a client system is determined. According to an embodiment of the present invention, the characteristics of the client system may include a list of data stored locally on the client system, a location of the client system, the type of hardware on the client system, attributes of the user(s) of the client system, and other characteristics.

At 402, data in a server database that is relevant to a client system is identified. According to an embodiment of the present invention, the relevance of the data may be determined from the characteristics of the client system.

At 403, it is determined whether a copy of the relevant data is stored locally on the client system. According to an embodiment of the present invention, the relevant data identified at 402 is compared with a list of data stored locally at the client system. If a copy of the relevant data is at the client system, control proceeds to 405. If a copy of the relevant data, is not at the client system, control proceeds to 404.

At 404, the relevant data is transmitted to the client system. The relevant data is stored locally on the client system.

At 405, it is determined whether data stored locally on the client system is current. According to an embodiment of the present invention, a creation date of a copy of data on the client system is compared with a creation date of corresponding data stored on the server system. If data on the server system has a more recent creation than its copy on the client system, the copy stored on the client system is determined to be not current. If data stored locally on the client system is current, control returns to 401. If data stored locally on the client system is not current, control proceeds to 406.

At 406, the server system transmit the current copy of the data to the client system. The data is stored locally on the client system. Control returns to 401. According to an embodiment of the present invention, the procedure shown in FIG. 4 is performed periodically to synchronize the local database of a client system. In one embodiment, the procedure may be performed each time location information about a client system and/or a list of data on the client system is transmitted to the server system.

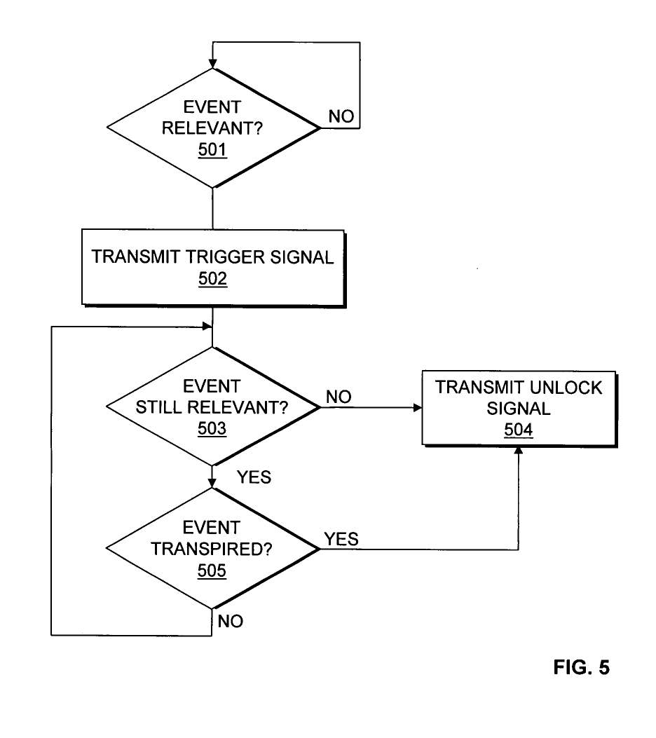

FIG. 5 is a flow chart illustrating a method for dispatching data according to an embodiment of the present invention. At 501, it is determined whether an event is relevant to a client system. According to an embodiment of the present invention, the relevance of an event may be determined by comparing a location of the event with the location of the client system. It should be appreciated that other criteria may be used. If the event is not relevant, control returns to 501. If the event is relevant, control proceeds to 502.

At 502, a trigger signal is transmitted to the client system. According to an embodiment of the present invention, the trigger signal identifies data on the client system to present to a user of the client system and prompts the client system to lock the client system and prevent the user from performing regular computing operations.

At 503, it is determined whether the event is still relevant to the client system. According to an embodiment of the present invention, if an attribute of the client system that made the event initially relevant has changed, it may be determined that the event is no longer relevant. For example, if the event is location specific, the event may be determined to be irrelevant to the client system if the client system has moved outside the location. If it is determined that the event is no longer relevant, control proceeds to 504. If it is determined that the event is still relevant, control proceeds to 505.

At 504, an unlock signal is transmitted to the client system. The unlock signal prompts the client system to unlock the client system and allow the user to resume performing regular computing operations.

At 505 it is determined whether the event has transpired. According to an embodiment of the present invention, a determination that an event has transpired may be determined by receiving a notification that the event has transpired. If the event has transpired control proceeds to 504. If the event has not transpired, control returns to 503.

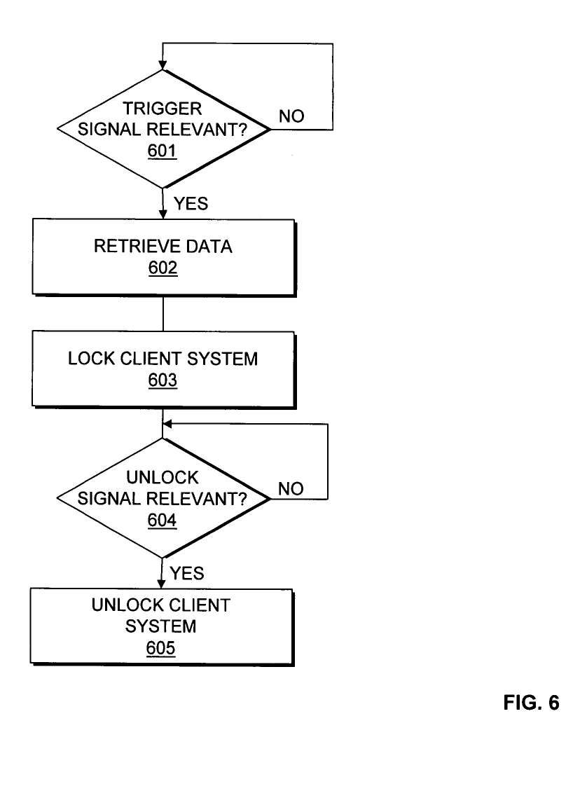

FIG. 6 is a flow chart illustrating a method for managing a client system according to an alternate embodiment of the present invention. At 601, it is determined whether a broadcast trigger signal is relevant to a client system. According to an embodiment of the present invention, a location tag indicating that the trigger signal is applicable to systems at a specified location is compared with a current location of the client system. If the locations match, the trigger signal is determined to be relevant to the client system. If it is determined that the trigger signal is not relevant, control returns to 601. If it is determined that the trigger signal is relevant, control proceeds to 602.

At 602, data identified by the trigger signal is retrieved for presentation. According to an embodiment of the present invention, the data identified is stored locally at the client system.

At 603, the client system is locked. Locking the client system prevents a user from performing regular computing operations on the client system.

At 604, it is determined whether a broadcast unlock signal is relevant to a client system. According to an embodiment of the present invention, a location tag indicating that the unlock signal is applicable to systems at a specified location is compared with a current location of the client system. If the locations match, the unlock signal is determined to be relevant to the client system. If it is determined that the unlock signal is not relevant, control returns to 604. If it is determined that the unlock signal is relevant, control proceeds to 605.

At 605, the client system is unlocked. Unlocking the client system allows a user to resume performing regular computing operations on the client system.

FIGS. 4-6 are flow charts illustrating a method of synchronizing data, a method for dispatching data, and a method for managing a client system according to embodiments of the present invention. Some of the techniques illustrated in these figures may be performed sequentially, in parallel or in an order other than that which is described. It should be appreciated that not all of the techniques described are required to be performed, that additional techniques may be added, and that some of the illustrated techniques may be substituted with other techniques.

The techniques described herein are not limited to any particular hardware or software configuration. They may find applicability in any computing or processing environment. The techniques may be implemented in hardware, software, or a combination of the two. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements). One of ordinary skill in the art may appreciate that the embodiments of the present invention can be practiced with various computer system configurations, including multiprocessor systems, minicomputers, mainframe computers, and other systems. The embodiments of the present invention can also be practiced in distributed computing environments where tasks may be performed by remote processing devices that are linked through a communications network.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating that the execution of the software by a processing system causes the processor to perform an action to produce a result.

In the foregoing specification the invention has been described with reference to specific exemplary embodiments thereof. It will, however, be evident that various modifications and changes may be made thereto without departing from the broader spirit and scope of the embodiments of the invention. The specification and drawings are, accordingly, to be regarded in an illustrative rather than restrictive sense.

1. A method for managing data, comprising:
synchronizing a database on a client system in response to location information about the client system; and
transmitting a trigger signal to the client system that prompts the client system to present data from the database and to lock the client system in response to an event relevant to the location information of the client system.

2. The method of claim 1, wherein synchronizing the database on the client system comprises:
determining whether the database has data corresponding to the location information; and
transmitting the data to the database if the database does not have the data.

3. The method of claim 1, wherein synchronizing the database on the client system comprises:
determining whether the database has a current version of data corresponding to the location information; and
transmitting the current version of data to the database if the database does not have the data.

4. The method of claim 1, wherein the data presented by the client system is a splash screen.

5. The method of claim 1, further comprising transmitting an unlock signal to the client system that prompts the client system to unlock the client system.

6. The method of claim 1, further comprising storing the location information received from the client system.

7. The method of claim 1, further comprising:
determining whether the client system is in a range of a server system; and
transferring responsibility of synchronizing the database to the server system.

8. A method for managing data, comprising:
synchronizing databases on client systems in response to location information from the client systems; and
broadcasting a trigger signal with a location tag that prompts a client system at a location that matches the location tag to present data from its database and to lock the client system.

9. The method of claim 8, wherein synchronizing the databases on the client systems comprises:
determining whether the databases have data corresponding to the location information; and
transmitting the data to the databases if the databases do not have the data.

10. The method of claim 8, wherein synchronizing the databases on the client systems comprises:
determining whether the databases have current versions of data corresponding to the location information; and
transmitting the current versions of the data to the databases if the databases do not have the data.

11. The method of claim 8, wherein the data presented by the client system is a splash screen.

12. The method of claim 8, further comprising broadcasting an unlock signal with a second location tag that prompts a client system at a location that matches the second location tag to unlock the client system.

13. The method of claim 8, further comprising:
determining whether a client system is in range of a server system; and
transferring responsibility of synchronizing a database of the client system to the server system.

14. A method for managing data, comprising:
determining whether a broadcast trigger signal is targeted to a client system; and
presenting data identified by the trigger signal and locking the client system if the broadcast trigger signal is targeted to the client system.

15. The method of claim 14, wherein determining whether the broadcast trigger signal is targeted to the client system comprises comparing a location tag of the broadcast trigger signal to a location of the client system.

16. The method of claim 14, wherein presenting the data specified by the trigger signal comprises presenting a splash screen stored on the client system.

17. The method of claim 14, further comprising:
transmitting location information to a server system; and
storing data, relevant to the location information, received from a server system.

18. The method of claim 14, further comprising:
determining whether a broadcast unlock signal is targeted to the client system; and
unlocking the client system if the broadcast unlock system is targeted to the client system.

19. The method of claim 18, wherein determining whether the broadcast unlock signal is targeted to the client system comprises comparing a location tag of the broadcast unlock signal to a location of the client system.

20. A machine-readable medium having stored thereon sequences of instructions, the sequences of instructions including instructions which, when executed by a processor, causes the processor to perform:
synchronizing a database on a client system in response to location information about the client system; and
transmitting a trigger signal to the client system that prompts the client system to present data from the database and to lock the client system in response to an event relevant to the location information of the client system.

21. The machine-readable medium of claim 20, wherein synchronizing the database on the client system comprises:
determining whether the database has data corresponding to the location information; and
transmitting the data to the database if the database does not have the data.

22. The machine-readable medium of claim 20, wherein synchronizing the database on the client system comprises:
determining whether the database has a current version of data corresponding to the location information; and
transmitting the current version of data to the database if the database does not have the data.

23. A localized data dispatcher unit, comprising:
a data subsystem to synchronize contents of a local database in a client system; and
a trigger/unlock subsystem to transmit a trigger signal that prompts the client system to present data from the local database and to lock the client system in response to an event.

24. The localized data dispatcher unit of claim 23, wherein the data subsystem comprises a data manager to determine whether data is relevant to the client system in response to a current location of the client system.

25. The localized data dispatcher unit of claim 23, wherein the trigger/unlock subsystem comprises a trigger/unlock manager to determine whether the event is relevant to the client system based on a current location of the client system and a location associated with the event.
